(19) United States
(12) Patent Application Publication
(10) Pub. No.: US 2019/0299764 A1
(43) Pub. Date: Oct. 3, 2019

(54) THERMOPLASTIC ELASTOMER COMPOSITION, WEATHERSTRIP AND MANUFACTURING METHOD THEREOF

(71) Applicants: TOYODA GOSEI CO., LTD., Kiyosu-shi (JP); CHUBU UNIVERSITY EDUCATIONAL FOUNDATION, Kasugai-shi (JP)

(72) Inventors: Seira MORIYA, Kasugai-shi (JP); Ryota KISHI, Kiyosu-shi (JP); Hidekazu KURIMOTO, Kiyosu-shi (JP); Yasuhiro YAMAGUCHI, Kiyosu-shi (JP)

(21) Appl. No.: 16/359,156

(22) Filed: Mar. 20, 2019

(30) Foreign Application Priority Data
Mar. 29, 2018 (JP) 2018-064747

(51) Int. Cl. B60J 10/17; B29C 48/00; C08K 3/04; C08K 9/04; C08J 3/22; B60J 10/76

(52) U.S. Cl. CPC B60J 10/17; B29C 48/022; C08K 3/04; B29K 2021/003; C08J 3/226; B60J 10/76; C08K 9/04

(57) ABSTRACT

A thermoplastic elastomer composition includes 15 mass % or more and 36 mass % or less of organically modified nanodiamond contained in a base material formed of dynamically cross-linked thermoplastic elastomer. Good sliding property is obtained and excellent wear resistance is realized by containing the 15 mass % or more of organically modified nanodiamond.

### CROSS-REFERENCE TO RELATED APPLICATION(S)

This application is based upon and claims the benefit of priority from Japanese Patent Application No. 2018-064747, filed on Mar. 29, 2018, the entire contents of which are incorporated herein by reference.

### BACKGROUND

### 1. Field of the Invention

The present invention relates to a thermoplastic elastomer composition, a weatherstrip using the thermoplastic elastomer composition, and a manufacturing method thereof.

### 2. Description of the Related Art

A weatherstrip is generally formed of an olefin polymer (rubber, thermoplastic resin, or thermoplastic elastomer). Among weatherstrips, particularly in a glass run which is attached to a window frame and on which a windowpane slides, it is necessary to enhance sliding property with the windowpane in order to prevent generation of abnormal noise and the like when the window glass slides.

In the related art, there is known a method in which a thin protective film adheres to a contact surface with the windowpane in order to improve the sliding property, and a roughened surface portion such as irregularities is formed on a surface of the thin protective film to reduce the sliding resistance with the windowpane (for example, see JP-B-H07-73893).

There is also known a method of forming a surface of the sliding portion for glass in the weatherstrip, using a sliding material obtained from a material in which a predetermined lubricant is mixed in an olefin polymer. As the lubricant, a solid skid formed of graphite (for example, see JP-A-2016-98336) or a fixed skid such as mica or molybdenum (for example, see Japanese Patent No. 2864054) is used.

However, in the former method in which the roughened surface portion such as irregularities is provided on the sliding portion for the windowpane, initial sliding property is inferior and wear of the sliding portion according to repeated sliding of the windowpane tends to proceed.

On the other hand, in the latter method using the skid such as graphite, although it can be said that the initial sliding property is good, wear of the sliding portion according to sliding of the windowpane tends to occur. When the sliding portion wears out, the skid on the surface of the sliding portion will peel off and there is a possibility that the sliding property will deteriorate over time.

### SUMMARY

The present invention is made in view of the above circumstances, and an object thereof is to provide a thermoplastic elastomer composition capable of improving sliding property or wear resistance, weatherstrip, and a manufacturing method thereof.

According to a first aspect of the invention, there is provided a thermoplastic elastomer composition including 15 mass % or more and 36 mass % or less of organically modified nanodiamond contained in a base material formed of dynamically cross-linked thermoplastic elastomer.

According to the first aspect, the thermoplastic elastomer composition contains 15 mass % or more of organically modified nanodiamond (hereinafter, the nanodiamond is also referred to as “ND”). ND is contained, whereby hardness of at least a composition surface can be enhanced and good sliding property can be obtained.

According to the first aspect, the organically modified ND is used instead of simple ND. When the organically modified ND is used, it is possible to increase compatibility of organically modified ND to the base material formed of the dynamically cross-linked thermoplastic elastomer (hereinafter, may be simply referred to as “TPV”).

Accordingly, agglomeration of ND in the base material can be effectively suppressed to remarkably enhance dispersibility of the ND in the base material, and familiarity of the ND to the base material (TPV) can be made good. Therefore, it is possible to make the ND easier to remain in the base material (to make ND does not easily peel off when frictional force is applied). With the fact that the organically modified ND is contained at 15 mass % or more to obtain high hardness, excellent wear resistance can be realized. As a result, good sliding property can be maintained over a long period of time.

It is possible to prevent a surface state from deteriorating due to aggregation of ND, by enhancing the dispersibility of ND. Therefore, good appearance quality can also be more reliably and easily obtained.

On the other hand, according to the first aspect, a content of the organically modified ND is set to 36 mass % or less. Therefore, it is possible to prevent the composition from becoming excessively hard to ensure sufficient flexibility. In addition, it is possible to improve ease or convenience in processing such as extrusion molding.

According to a second aspect of the invention, in the thermoplastic elastomer composition according to the first aspect, an organic modifying group bonded to a surface of the nanodiamond may be CH₃(CH₂)ₙNH₂ (n is an integer of 1 or more), and n is 13 or more, in the organically modified nanodiamond.

According to the second aspect, the compatibility of the organically modified ND to the base material can be improved more reliably. Accordingly, the dispersibility of the ND can be further enhanced, and the wear resistance can be further effectively improved.

As n increases, the compatibility of the organically modified ND to the base material can be enhanced. It is preferable to satisfy a relation of n≥15, and is more preferable to satisfy a relation of n≥17.

According to a third aspect of the invention, there is provided a weatherstrip including a sliding portion having a surface where a windowpane slides, wherein at least the sliding portion is formed of the thermoplastic elastomer composition according to the first aspect or the second aspect.

According to the third aspect, in the sliding portion for the windowpane in the weatherstrip, it is possible to effectively improve the wear resistance while making the sliding property good. Therefore, good sliding property can be maintained over a long period of time.

According to a fourth aspect of the invention, there is provided a manufacturing method of a weatherstrip including a sliding portion having a surface where a windowpane slides, in which at least the sliding portion is formed of the thermoplastic elastomer composition according to the first aspect or the second aspect, the method including: preparing a masterbatch including olefin thermoplastic resin and organically modified nanodiamond; and melting and kneading the masterbatch and olefin rubber while supplying to an extruder to perform dynamic crosslinking to obtain the thermoplastic elastomer composition.

According to the fourth aspect, the thermoplastic elastomer composition is manufactured in a manner that the masterbatch containing the organically modified ND and olefin thermoplastic resin (for example, in pellet form or chip form) and the olefin rubber are supplied to the extruder to perform melting and kneading and dynamic crosslinking (depending on a composition ratio of a composition to be manufactured, olefin thermoplastic resin or the like other than the masterbatch can be supplied to the extruder). When preparing the masterbatch in advance, the organically modified ND can be sufficiently dispersed in the olefin thermoplastic resin and at the time of melting and kneading, a dispersion inhibition of the ND due to an influence of the olefin rubber can be more reliably suppressed. Accordingly, it is possible to remarkably enhance the dispersibility of the ND in the base material, and familiarity of the ND to the base material (TPV) can be made better. Therefore, it is possible to make the ND easier to remain in the base material (to make it difficult for ND to peel off when frictional force is applied), and more excellent wear resistance can be obtained. As a result, good sliding property can be further maintained over a long period of time.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a schematic front diagram illustrating a schematic configuration of a door;

FIG. 2 is a sectional diagram of J-J line of FIG. 1, in a state where door glass enters an inside of a body part;

FIG. 3 is a schematic diagram when dynamic crosslinking is performed by melting and kneading a masterbatch and olefin rubber:

FIG. 4A is a schematic diagram illustrating a test piece in the wear resistance test:

FIG. 4B is a schematic sectional diagram illustrating the test piece of which wear amount is measured:

FIG. 5A is a sectional photograph of a thermoplastic elastomer composition including organically modified ND;

FIG. 5B is a sectional photograph of a thermoplastic elastomer composition including unmodified ND:

FIG. 6 is a graph illustrating test results of the wear resistance test on samples in which the content of the organically modified ND are different from each other:

FIG. 7 is a graph illustrating test results of a hardness measurement test on samples in which the content of the organically modified ND are different from each other:

FIG. 8 is a graph illustrating test results of wear resistance test on a sample containing the organically modified ND and other samples; and

FIG. 9 is a graph illustrating test results of a friction coefficient measurement test on samples in which the content of the organic modified ND are different from each other.

### DETAILED DESCRIPTION OF THE INVENTION

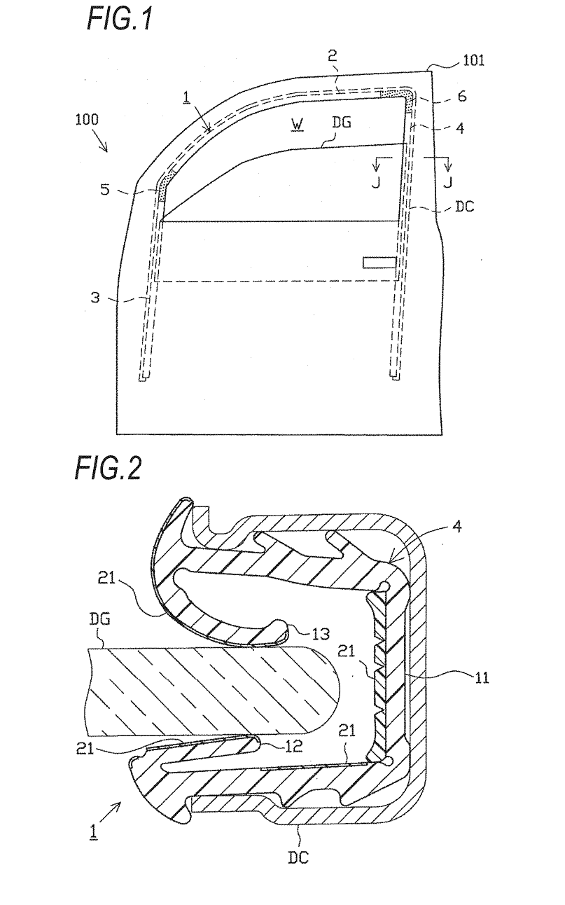

Hereinafter, an embodiment will be described with reference to the drawings. As illustrated in FIG. 1, a front door 100 which can be opened and closed in an opening portion for a door of a vehicle is provided with a door glass DG as a windowpane capable of moving up and down and a glass run 1 as a weatherstrip which is provided corresponding to an outer shape of the door glass DG, guides the door glass to move up and down, and seals a gap between a periphery of the door glass DG and a door frame 101 when the door glass DG rises and the window W is closed.

The glass run 1 is configured to include an extrusion molded part 2 corresponding to an upper side part, extrusion molded parts 3 and 4 corresponding to front and rear longitudinal side parts, and molded parts 5 and 6 (a portion with a dotted pattern) respectively connecting ends of the extrusion molded parts 2 and 3 to each other and ends of the extrusion molded parts 2 and 4 to each other. The glass run 1 is attached to a channel part DC which is formed along an outer periphery of the window W.

The glass run 1 is formed of olefin thermoplastic elastomer (TPO). Further, as illustrated in FIG. 2, the extrusion molded part 4 corresponding to a rear edge part of the door glass DG in the glass run 1 includes a main body part 11 having a U-shaped cross section to be fitted into the channel part DC and an extra-vehicle seal lip 12 and an intra-vehicle seal lip 13 which are formed to protrude from the main body part 11. In a state where the window W is closed with the door glass DG, the extra-vehicle seal lip 12 is pressed against an outside surface of the door glass DG and the intra-vehicle seal lip 13 is pressed against an inside surface of the door glass DG. Accordingly, an extra-vehicle side and an intra-vehicle side of the door glass DG are sealed, respectively.

In the present embodiment, a sliding portion 21 configured to improve sliding property for the door glass DG is formed on a portion of the extra-vehicle seal lip 12 where the door glass DG slides, a portion of the intra-vehicle seal lip 13 where the door glass DG slides, and an inner part of the main body part 11. The sliding portion 21 is a layer portion formed at the same time as the main body part 11, the extra-vehicle seal lip 12, or the like during extrusion molding, and is formed of a predetermined thermoplastic elastomer composition. The thermoplastic elastomer composition will be described later.

The extrusion molded part 4 corresponding to the rear edge part of the door glass DG has been described above; however, the extrusion molded parts 2 and 3 and the molded parts 5 and 6 also have the same form including the main body part 11, seal lips 12 and 13, and the sliding portion 21 formed corresponding to the sliding region for the door glass DG, as the extrusion molded part 4.

Next, the above-described thermoplastic elastomer composition forming the sliding portion 21 will be described. The thermoplastic elastomer composition is formed to contain 15 mass % or more and 36 mass % or less of the organically modified nanodiamond (hereinafter, the nanodiamond may simply be referred to as “ND”) in a base material formed of dynamically cross-linked thermoplastic elastomer (hereinafter, may simply be referred to as “TPV”). The TPV has a sea-island structure in which cross-linked rubber as a domain (island phase) is dispersed in thermoplastic resin as a matrix (sea phase). The TPV in the present embodiment includes polypropylene (PP) which is one of olefin thermoplastic resin and ethylene-propylene-diene copolymer rubber (EPDM) which is one of olefin rubber.

As the olefin thermoplastic resin, in addition to the PP, polyethylene (PE) or the like can be used. In addition, as the olefin rubber, in addition to the EPDM, an ethylene-α-olefin copolymer such as ethylene-propylene rubber (EPM), ethylene-butylene copolymer (EBM), and ethylene-octene copolymer (EOM) can be used. In addition, plural kinds thereof can be selected to be used.

A content ratio of the olefin thermoplastic resin in TPV is not particularly limited, and preferably 10 mass % or more and 90 mass % or less. A content ratio of the olefin rubber is also not particularly limited, and preferably 10 mass % or more and 80 mass % or less. In a case where a total content of the olefin thermoplastic resin and the olefin rubber is less than 100 mass %, a remainder includes process oil and the like.

In the organically modified ND, an organic modifying group is bonded to a surface thereof. As the organic modifying group bonded to the surface of the ND, CH₃(CH₂)ₙNH₂ where n is 13 or more is preferably used (n is an integer of 1 or more). That is, CH₃(CH₂)₁₃NH₂ (tetradecylamine). CH₃(CH₂)₁₅NH₂ (hexadecylamine), CH₃(CH₂)₁₇NH₂ (octadecylamine), and the like are preferably used. In particular, a group having a large number of carbon atoms is preferable, in an aspect of compatibility of ND to the base material. Accordingly, the CH₃(CH₂)₁₅NH₂ is more preferable, and the CH₃(CH₂)₁₇NH₂ is still more preferable. As the organic modifying group, an organic modifying group having n less than 13, such as CH₃(CH₂)₁₁NH₂ (dodecylamine) can be used. In addition, as a functional group, a carboxyl group (—COOH) or a hydroxyl group (—OH) may be used in place of an amino group.

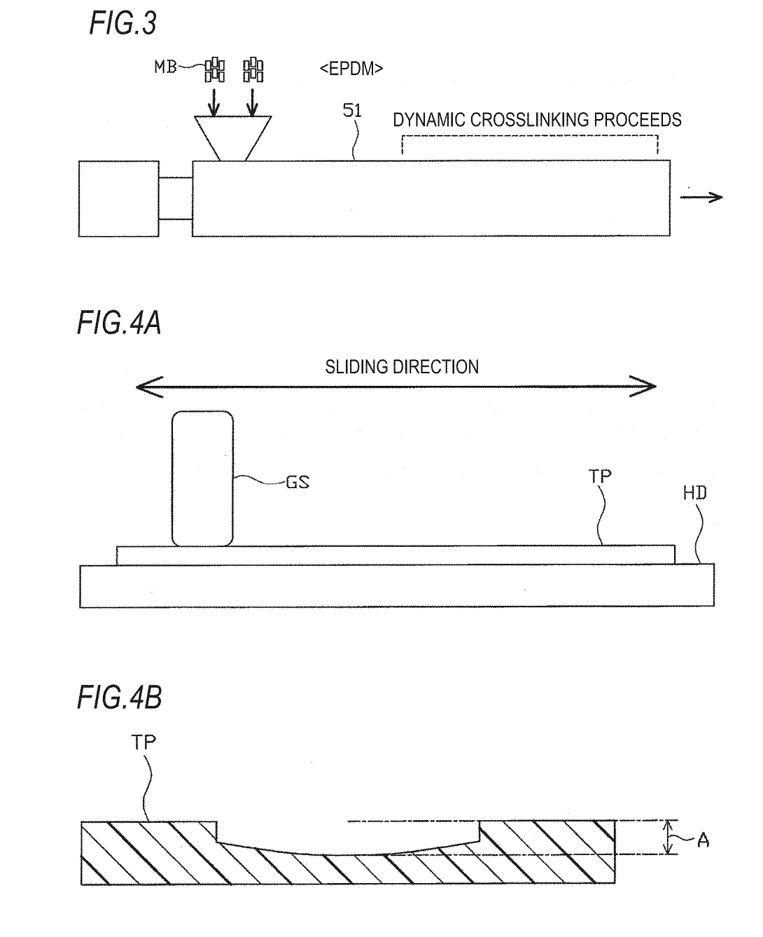

Next, in the manufacturing method of the glass run 1, a manufacturing method of the thermoplastic elastomer composition described above will be mainly described in particular. First, masterbatches MBs in a pellet form or a chip form (see FIG. 3) including olefin thermoplastic resin (in the present embodiment, PP) and organically modified ND are prepared in advance. The masterbatches MBs can be obtained in a manner that, for example, the organically modified ND is kneaded in molten olefin thermoplastic resin and sufficiently dispersed and the olefin thermoplastic resin in which the organically modified ND has been dispersed is pelletized (chipized) by a predetermined pelletizer or the like.

Next, as illustrated in FIG. 3, the masterbatches MBs and uncross-linked olefin rubber (in the present embodiment, EPDM) are put into a predetermined twin screw kneading extruder 51 as the extruder, along with compatibilizer, carbon, a crosslinking agent, an antioxidant, and plasticizer. Depending on a composition ratio of the thermoplastic elastomer composition to be manufactured, olefin thermoplastic resin other than the olefin thermoplastic resin forming the masterbatches MBs may be separately added. In addition, after adding the masterbatches MBs, the olefin rubber, or the like, in a stage in which the masterbatches MBs, the olefin rubber, or the like are kneaded to a certain extent, the crosslinking agent may be added.

The olefin rubber (EPDM) is subjected to dynamic crosslinking while melting and kneading the olefin thermoplastic resin (PP) and the uncross-linked olefin rubber (EPDM) by shearing using a rotation of twin screw in a process of passing through the extruder 51, thereby obtaining the thermoplastic elastomer composition in which the organically modified ND is contained in the base material formed of the TPV, in a dispersed state.

The kneading and the dynamic crosslinking may be performed in parallel (at the same time), or the dynamic crosslinking may be performed after the kneading. However, from the viewpoint of making particles of the cross-linked rubber smaller, it is preferable to perform the dynamic crosslinking after performing the kneading to a certain extent.

In manufacturing of the glass run 1, when using a molding method (such as two-color simultaneous extrusion molding or a two-color molding method using a slide mold) used for known molding of thermoplastic resin, such as extrusion molding or molding, it is possible to obtain the glass run 1, in which the sliding portion 21 formed of the thermoplastic elastomer composition described above is not formed on the surface of the main body part 11 or the seal lips 12 and 13 formed of TPO.

As described above, according to the present embodiment, the thermoplastic elastomer composition contains 15 mass % or more of the organically modified ND. Therefore, since it is presumed that the organically modified ND is dispersed in a large amount in the PP as the sea phase, the hardness of at least a composition surface can be enhanced and good sliding property can be obtained in the sliding portion 21.

In addition, when using the organically modified ND instead of simple ND, the compatibility of the organically modified ND to the base material can be enhanced. Accordingly, agglomeration of ND in the base material can be effectively suppressed to remarkably enhance dispersibility of the ND in the base material, and familiarity of the ND to the base material (TPV) can be made good. Therefore, it is possible to make the ND easier to remain in the base material (to make ND does not easily peel off when frictional force is applied). With the fact that the organically modified ND is contained at 15 mass % or more to obtain high hardness, excellent wear resistance can be realized. As a result, good sliding property can be maintained over a long period of time.

Also, it is possible to prevent a surface state from deteriorating due to aggregation of ND, by enhancing the dispersibility of ND. Accordingly, good appearance quality can also be more reliably and easily obtained.

On the other hand, a content of the organically modified ND is set to 36 mass % or less. Therefore, it is possible to prevent the composition from becoming excessively hard to ensure sufficient flexibility. As a result, it is possible to improve ease or convenience in processing such as extrusion molding.

In the organically modified ND, CH₃(CH₂)NH₂ is used as the organic modifying group, and n is 13 or more. Therefore, the compatibility of the organically modified ND to the base material can be improved more reliably. As a result, the dispersibility of the ND can be further enhanced, and the wear resistance can be further effectively improved.

Also, the thermoplastic elastomer composition is manufactured in a manner that the masterbatch MB containing the organically modified ND and the olefin thermoplastic resin (PP) and the olefin rubber (EPDM) are supplied to the twin screw kneading extruder 51 to perform melting and kneading and dynamic crosslinking. When preparing the masterbatch MB in advance, the organically modified ND can be sufficiently dispersed in the olefin thermoplastic resin (PP) and at the time of melting and kneading, a dispersion inhibition of the ND due to an influence of the olefin rubber (EPDM) can be more reliably suppressed. Accordingly, it is possible to remarkably enhance the dispersibility of the ND in the base material, and familiarity of the ND to the base material (TPV) can be made better. Therefore, it is possible to make the ND easier to remain in the base material (to make it difficult for ND to peel off when frictional force is applied), and more excellent wear resistance can be obtained. As a result, good sliding property can be further maintained over a long period of time.

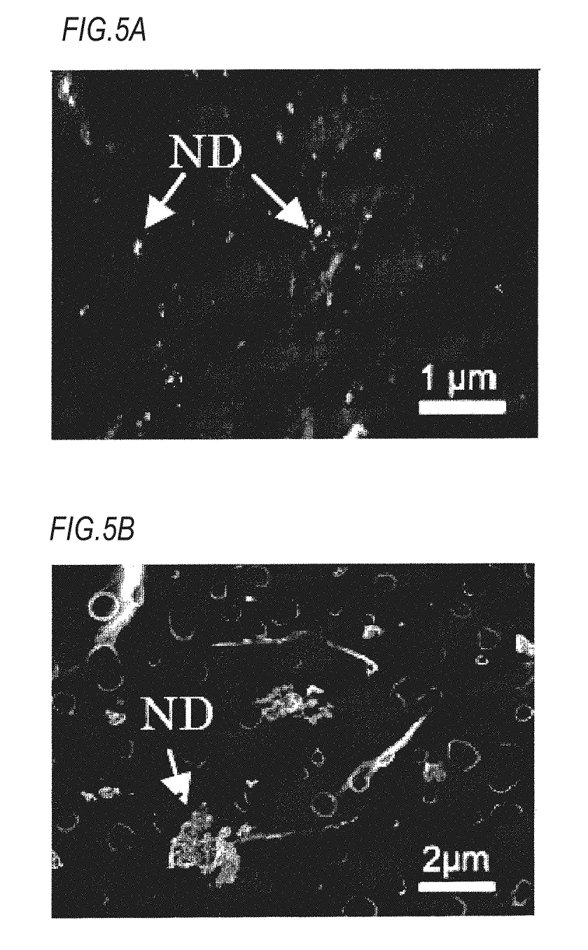

Next, in order to confirm the operational effects achieved by the embodiment, Sample X (Example) of the thermoplastic elastomer composition in which the organically modified ND is contained in the base material formed of TPV and Sample Y (Comparative Example) of the thermoplastic elastomer composition in which the unmodified ND is contained in the base material (TPV) were prepared (such that the ND components have the same mass), and each section of Samples X and Y was observed using a scanning electron microscope (SEM) to confirm a dispersed state of the ND. FIG. 5A illustrates an SEM image of Sample X. FIG. 5B illustrates an SEM image of Sample Y. In Sample X, an organically modified ND to which CH₃(CH₂)₁₇NH₂ (octadecylamine) was bonded was used.

As illustrated in FIG. 5B, several μm order of aggregation of the ND was confirmed in Sample Y using the unmodified ND, and which turned out deterioration in dispersibility. On the contrary, as illustrated in FIG. 5A, no noticeable aggregation of the ND was confirmed in Sample X containing organically modified ND, and it was found to have good dispersibility. It is considered that it is due to that when using the organically modified ND, the dispersibility of ND to the base material (TPV) was improved.

From the above results, it can be said that it is preferable to use the organically modified ND, from the viewpoint of making the dispersibility of ND to the base material (TPV) good and enhancing the wear resistance.

Next, Sample 1 (TPV simple substance) formed of TPV in which the organically modified ND was not mixed, Sample 2 in which 0.8 mass % of the organically modified ND was mixed in TPV as the base material, Sample 3 in which 5 mass % of the organically modified ND was mixed in the base material (TPV), Sample 4 in which 15 mass % of the organically modified ND was mixed in the base material (TPV), and Sample 5 in which 36 mass % of the organically modified ND was mixed in the base material (TPV) were prepared. A wear resistance test and a hardness measurement test were performed on each sample.

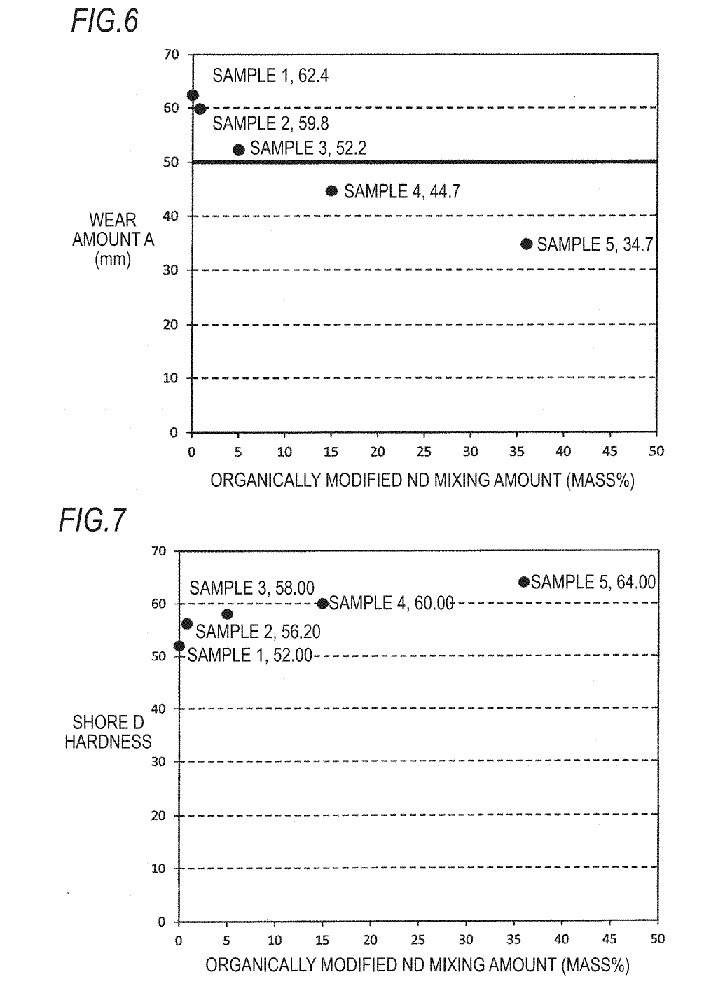

An outline of the wear test is as follows. That is, as illustrated in FIGS. 4A and 4B, a test piece TP having a width of 20 mm, a length of 160 mm, and a thickness of 2 mm was produced using Samples 1 to 5. The test piece TP was mounted on a holder HD, and set to a testing machine. A glass wear sheet GS having a bottom of 50 mm in width×20 mm in length in a sliding direction (with RIO mm) is placed on (pressed against) the test piece TP in a state of applying load of 30 N. A surface of the test piece TP was reciprocated in a longitudinal direction thereof at a stroke of 100 mm at a sliding speed of 60 rpm/min, and a wear amount A (mm) of the test piece TP after 10,000 times of reciprocating was measured. In a case where the wear amount A was 50 μm or less, it was determined that the wear resistance was excellent. On the other hand, in a case where the wear amount A exceeded 50 μm, it was determined that the wear resistance deteriorated to some extent. FIG. 6 illustrates results of the wear resistance test on Samples 1 to 5. In FIG. 6, a name of the samples is followed by a value of the wear amount A.

In the hardness measurement test, shore d hardness D hardness of each of Samples 1 to 5 was obtained using a predetermined hardness tester, in accordance with JIS K 6253. FIG. 7 illustrates results of the hardness measurement test on Samples 1 to 5. In FIG. 7, a name of the samples is followed by a value of the shore D hardness.

Further, as a reference, Table illustrates a material mixing ratios of each of Samples 1 to 5. Samples 1 to 5 were prepared by mixing EPDM, PP (not mixed in Sample 5), masterbatch formed of the organically modified ND and PP, compatibilizer, carbon, a crosslinking agent, an antioxidant, and a plasticizer.

TABLE 1

| | | Sample No. | | | | | | | | | |
|---|---|---|---|---|---|---|---|---|---|---|---|
| | | Sample 1 | | Sample 2 | | Sample 3 | | Sample 4 | | Sample 5 | |
| | | ND mixing amount (mass %) | | | | | | | | | |
| | | 0 | | 0.8 | | 5 | | 15 | | 36 | |
| | | parts by | | parts by | | parts by | | parts by | | parts by | |
| | | mass (parts | mass % | mass (parts | mass % | mass (parts | mass % | mass (parts | mass % | mass (parts | mass % |
| | | by weight) | (wt %) | by weight) | (wt %) | by weight) | (wt %) | by weight) | (wt %) | by weight) | (wt %) |
| Mixing | EPDM (EPM) | 23.32 | 24.9% | 23.32 | 24.7% | 23.32 | 23.6% | 23.32 | 21.2% | 23.32 | 16.0% |
| | PP | 52.50 | 56.0% | 51.74 | 54.8% | 47.50 | 48.2% | 35.85 | 32.6% | 0.00 | 0.0% |
| | Organically | 0.00 | 0.0% | 1.52 | 1.6% | 9.94 | 10.1% | 33.00 | 30.0% | 105.00 | 71.8% |
| | modified ND-PP | | | | | | | | | | |
| | (Masterbatch) | | | | | | | | | | |
| | Compatibilizer | 2.50 | 2.7% | 2.50 | 2.6% | 2.50 | 2.5% | 2.50 | 2.3% | 2.50 | 1.7% |
| | Carbon | 3.00 | 3.2% | 3.00 | 3.2% | 3.00 | 3.0% | 3.00 | 2.7% | 3.00 | 2.1% |
| | Crosslinking | 1.53 | 1.6% | 1.53 | 1.6% | 1.53 | 1.6% | 1.53 | 1.4% | 1.53 | 1.0% |
| | agent | | | | | | | | | | |
| | Antioxidant | 0.10 | 0.1% | 0.10 | 0.1% | 0.10 | 0.1% | 0.10 | 0.1% | 0.10 | 0.1% |
| | plasticizer | 10.74 | 11.5% | 10.74 | 11.4% | 10.74 | 10.9% | 10.74 | 9.8% | 10.74 | 7.3% |
| | Total | 93.69 | 100.0% | 94.45 | 100.0% | 98.63 | 100.0% | 110.04 | 100.0% | 146.19 | 100.0% |

When describing these materials in more detail, “Mitsui EPT 3072EM” (ethylene=64%, diene=5.4%, and oil expansion amount=40 phr) (trade name, manufactured by Mitsui Chemicals, Inc.) was used as the EPDM, “NOVATEC PP EC7” (trade name, manufactured by Japan Polypropylene Corporation) was used as the PP, and “TAFMER XM-7080” (trade name, manufactured by Mitsui Chemicals. Inc.) was used as the compatibilizer. “MFP-CMB 45 L” (trade name, manufactured by Mifuku Kogyo Co., Ltd.) was used as the carbon, “TACKIROL 250-I” (trade name, manufactured by Taoka Chemical Industry Co., Ltd.) was used as the crosslinking agent, and “IRGANOX 1010” (trade name, manufactured by BASF Company Ltd.) was used as the antioxidant, and “Diana Process Oil PW-100” (trade name, manufactured by Idemitsu Kosan Co., Ltd.) was used as the plasticizer.

In addition, a masterbatch including the organically modified ND in which CH₃(CH₂)₁₇NH₂ (octadecylamine) was bonded to the surface of ND and PP by 50 mass % respectively was produced and used. Therefore, half of the mixing amount of the masterbatch content in Table 1 corresponds to the content of the organically modified ND in samples 1 to 5. For example, in Sample 4, the mixing amount of the masterbatch is 30.0 mass %. Therefore, the content of the organically modified ND is 15 mass %.

As illustrated in FIG. 6, it was found that, in Samples 4 and 5 containing 15 mass % or more of organically modified ND, the wear amount was 44.7 mm or 34.7 mm and excellent wear resistance was obtained. It is considered that it is due to the facts that the dispersibility of the ND to the base material (TPV) could be enhanced by using the organically modified ND and as can be seen from the results of the hardness measurement test in FIG. 7, the surface hardness could be sufficiently increased by setting the content of the organically modified ND to 15 mass % or more.

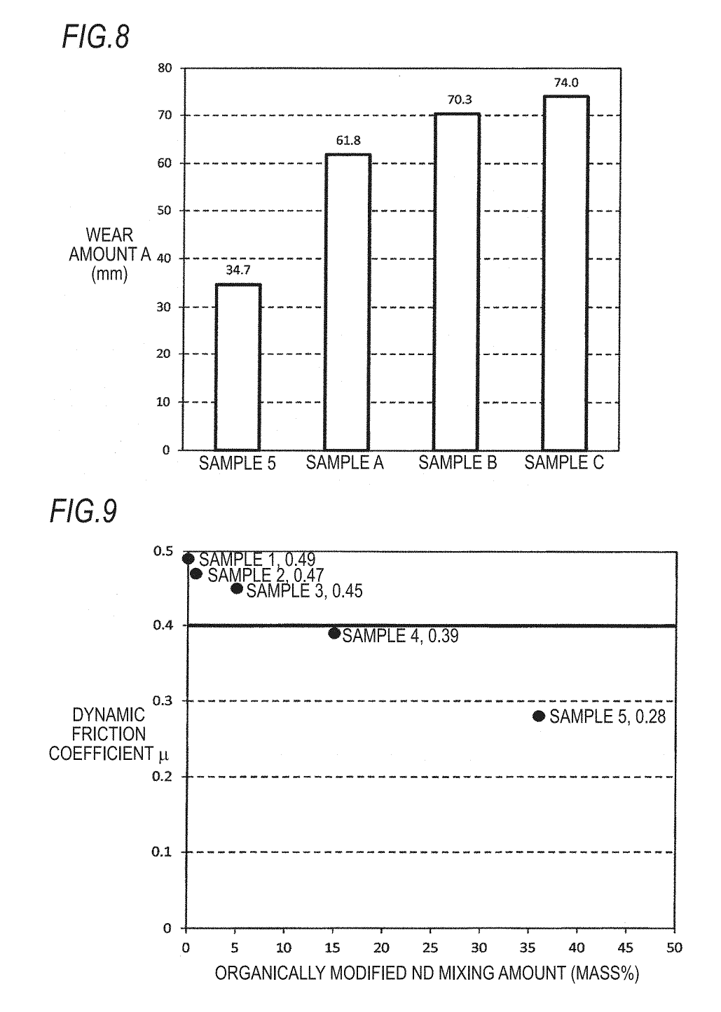

The above wear resistance test was performed on Samples A, B, and C prepared by mixing 36 mass % of CaCO₃, clay, or graphite as a skit into TPV as the base material. As a result, as illustrated in FIG. 8 (illustrated with the test results of Sample 5 in FIG. 8), it was found that the sample containing the organically modified ND was remarkably excellent in the wear resistance compared to those of Samples A to C. From this point of view, usefulness of inclusion of the organically modified ND was confirmed.

Next, a friction coefficient measurement test was conducted on Samples 1 to 5. An outline of the friction coefficient measurement test is as follows. That is, in accordance with JIS K 7125, a test piece having the same mass and the same sliding area (bottom area) was prepared by using each sample, and in a state of placing the test piece on a predetermined table, a dynamic friction coefficient μ was calculated from the load when moved at 100 mm/min. Then, in a case where the dynamic friction coefficient μ was 0.40 or less, it was determined that the sliding property was good. On the other hand, in a case where the dynamic friction coefficient μ exceeded 0.40, it was determined that the sliding property deteriorated to some extent. FIG. 9 illustrates results of the friction coefficient measurement test. In FIG. 9, a name of the samples is followed by a value of the dynamic friction coefficient μ.

As illustrated in FIG. 9, it was found that, in Samples 4 and 5 in which the content of organically modified ND was set to 15 mass % or more, the dynamic friction coefficient μ was 0.40 or less and excellent sliding property was obtained. It is considered that it is due to that the surface hardness could be sufficiently increased by setting the content of the organically modified ND to 15 mass % or more. In addition, irregularities were formed on the surface of the test piece slightly (to the extent not affect the appearance quality), and as a result, the contact area between the test piece and the table was reduced, which is also considered to be a factor.

A static friction coefficient of each of Samples 1 to 5 was also measured along with the dynamic friction coefficient, and it was the same tendency as the dynamic friction coefficient μ. That is, it was confirmed that by setting the content of the organically modified ND to 15 mass % or more, good sliding property can be obtained even at the time of starting.

From the results of the various tests, it can be said that it is preferable to contain organically modified ND by 15 mass % or more, from the viewpoint of obtaining good performance in each of the sliding property and the wear resistance. In order to prevent the thermoplastic elastomer composition from becoming excessively hard, it is preferable to contain 36 mass % or less of the organically modified ND.

The present invention is not limited to the description of the above embodiment, and for example, may be implemented as follows. Naturally, other application examples and modification examples which are not exemplified below are also possible.

(A) In the embodiment, a technical idea of the present invention is embodied to the glass run 1 as a weatherstrip; however, the technical idea of the present invention may also be applied to other weatherstrips where the windowpane can slide thereof, such as an inner weatherstrip or an outer weatherstrip.

(B) A shape of the glass run 1 in the embodiment is an example, and the shape of the glass run 1 may be appropriately changed. In addition, all of the glass run 1 may be formed by extrusion molding, or may be molded by molding.

In the embodiment, the sliding portion 21 has a configuration provided on a surface layer, but may also be formed on an entire cross section, by using the thermoplastic elastomer composition according to the present invention. Further, the sliding portion 21 may be provided only in the extrusion molded parts 2, 3, and 4.

(C) In the embodiment, as a method of obtaining the thermoplastic elastomer composition in which the organically modified ND is contained in the base material formed of TPV, examples thereof include a method in which the masterbatch MB and the uncross-linked olefin rubber are put into the twin screw kneading extruder to perform melting and kneading and dynamic crosslinking, and other methods may be used. For example, when the TPV is extrusion-molded to obtain a product such as the weatherstrip, the TPV and the organically modified ND may be mixed by an extruder.

What is claimed is:

1. A thermoplastic elastomer composition comprising
15 mass % or more and 36 mass % or less of organically modified nanodiamond contained in a base material formed of dynamically cross-linked thermoplastic elastomer.

2. The thermoplastic elastomer composition according to claim 1, wherein
in the organically modified nanodiamond, an organic modifying group bonded to a surface of the nanodiamond is CH₃(CH₂)ₙNH₂ (n is an integer of 1 or more), and n is 13 or more.

3. A weatherstrip comprising
a sliding portion having a surface where a windowpane slides, wherein
at least the sliding portion is formed of the thermoplastic elastomer composition according to claim 1.

4. A manufacturing method of a weatherstrip including a sliding portion having a surface where a windowpane slides, in which at least the sliding portion is formed of the thermoplastic elastomer composition according to claim 1, the method comprising:
preparing a masterbatch including olefin thermoplastic resin and organically modified nanodiamond; and
melting and kneading the masterbatch and olefin rubber while supplying to an extruder to perform dynamic crosslinking to obtain the thermoplastic elastomer composition.
